(19) United States
(12) Patent Application Publication
(10) Pub. No.: US 2013/0269835 A1
(43) Pub. Date: Oct. 17, 2013

(54) Woodworking Machine with Rapid Positioning Apparatus

(71) Applicant: Ben Yu, Taichung City (TW)

(72) Inventor: Ben Yu, Taichung City (TW)

(21) Appl. No.: 13/448,398

(22) Filed: Apr. 17, 2012

(51) Int. Cl. B27C 5/04

(52) U.S. Cl. 144/253.6

(57) ABSTRACT

A woodworking machine for a work piece includes a base frame, a work platform, a driving unit, a rotary cutter unit, a supporting panel movably provided on the work platform for biasing against a work piece when the cutting procedure is performed on the work piece, and a rapid positioning apparatus. The rapid positioning apparatus includes a first guiding member and a second guiding member spacedly extended from the supporting panel, wherein the first guiding member and the second guiding member are arranged to restrict a movement of the supporting panel on the work platform at a transverse direction of the first guiding member and the second guiding member such that the supporting panel is only capable of moving on the work platform along a predetermined direction which is substantially parallel to the first guiding member and the second guiding member.

### BACKGROUND OF THE PRESENT INVENTION

1. Field of Invention

The present invention relates to woodworking apparatus, and more particularly to a woodworking machine, such as a router, comprising a rapid positioning apparatus.

2. Description of Related Arts

Referring to FIG. 1 and FIG. 2 of the drawings, a conventional woodworking machine, such as a router, usually comprises a base frame 2, a work platform 3 supported on top of the base frame 2, a driving unit 4 supported by the base frame 2 at a position underneath the work platform 3, a rotary cutting unit 5 rotatably supported on the work platform 3 and is arranged to be driven by the driving unit 4, and a supporting panel 6 movably provided on the work platform 3. The work platform 3 has two sliding slots 7 transversely and spacedly formed on two sides thereof in a parallel manner. The conventional router further comprises a locking device comprising a plurality of bolt nuts 9 slidably mounted in the two sliding slots 7 respectively, and a plurality of locker bolts 8 operatively provided on the supporting panel 6 and is arranged to engage to the corresponding bolt nuts 9 in a threaded manner Thus, each of the locker bolts 8 can be threadedly rotated with respect to the corresponding bolt nut 9 and can penetrate the bolt nut 9 to bias against a bottom surface of the corresponding sliding slot 7. When the supporting panel 6 has moved to a desirable position, a user of the conventional router may screw the locker bolts 8 so as to allow them to bias against the bottom surface of the sliding slot 7 for locking the supporting panel 6 with respect to the work platform 3. When the supporting panel 6 has been locked with respect to the work platform 3, the rotary cutting unit 5 is arranged perform certain woodworking procedure on a work piece supported on the work platform 3 and is retained by the supporting panel 6.

A major disadvantage of this conventional woodworking machine is that since the supporting panel 6 can only be moved when the locker bolts 8 are loosened, when the user moves the supporting panel 6 to a desirable position, the supporting panel 6 may be subject to uneven moving force so that the supporting panel 6 may easily be misaligned with respect to the work platform 3. Moreover, when the supporting panel 6 is misaligned, and the user nevertheless tightens the locker bolts 8, the locker bolts 8 may bias against a side surface of the sliding slots 7 so as to affect the sliding movement of the supporting panel 6. In more serious circumstances, the supporting panel 6 may be stuck on the work platform 3 so as to seriously affect the normal operation of the router.

### SUMMARY OF THE PRESENT INVENTION

The invention is advantageous in that it provides a woodworking machine such as a router, which comprises a rapid positioning apparatus which is capable of accomplishing a smooth movement of the supporting panel so as to enhance an effectiveness and efficiency of corresponding woodworking procedures.

Another advantage of the invention is to provide a woodworking machine such as a router, which comprises a rapid positioning apparatus which is capable of finely and rapidly adjusting a position of the supporting panel so as to enhance an effectiveness of the corresponding woodworking procedures.

Additional advantages and features of the invention will become apparent from the description which follows, and may be realized by means of the instrumentalities and combinations particular point out in the appended claims.

According to the present invention, the foregoing and other objects and advantages are attained by providing a woodworking machine for a work piece, comprising:
a base frame;
a work platform supported on said base frame;
a driving unit supported by said base frame;
a rotary cutter unit supported on said work platform and is mechanically connected to said driving unit so that said driving unit is arranged to drive said rotary cutter unit to perform a predetermined cutting procedure on said work piece;
a supporting panel movably provided on said work platform for biasing against said work piece when said cutting procedure is performed on said work piece; and
a rapid positioning apparatus, which comprises a first guiding member and a second guiding member spacedly extended from said supporting panel, wherein said first guiding member and said second guiding member are arranged to restrict a movement of said supporting panel on said work platform at a transverse direction of said first guiding member and said second guiding member such that said supporting panel is only capable of moving on said work platform along a predetermined direction which is substantially parallel to said first guiding member and said second guiding member.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a conventional router.

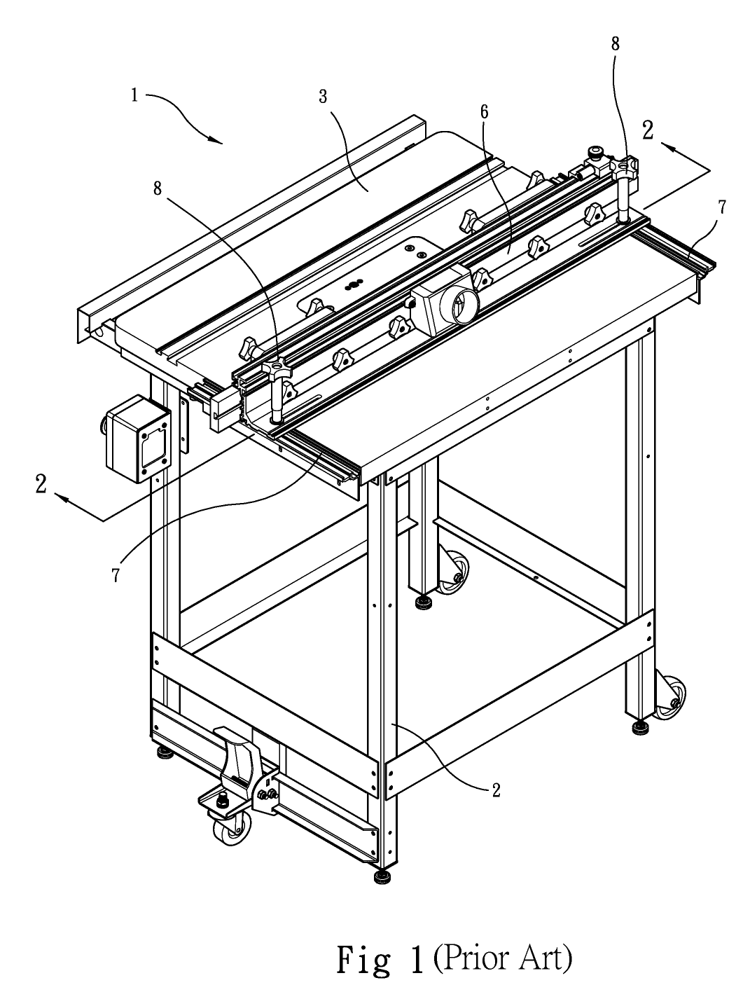

FIG. 2 is a side view of the conventional router.

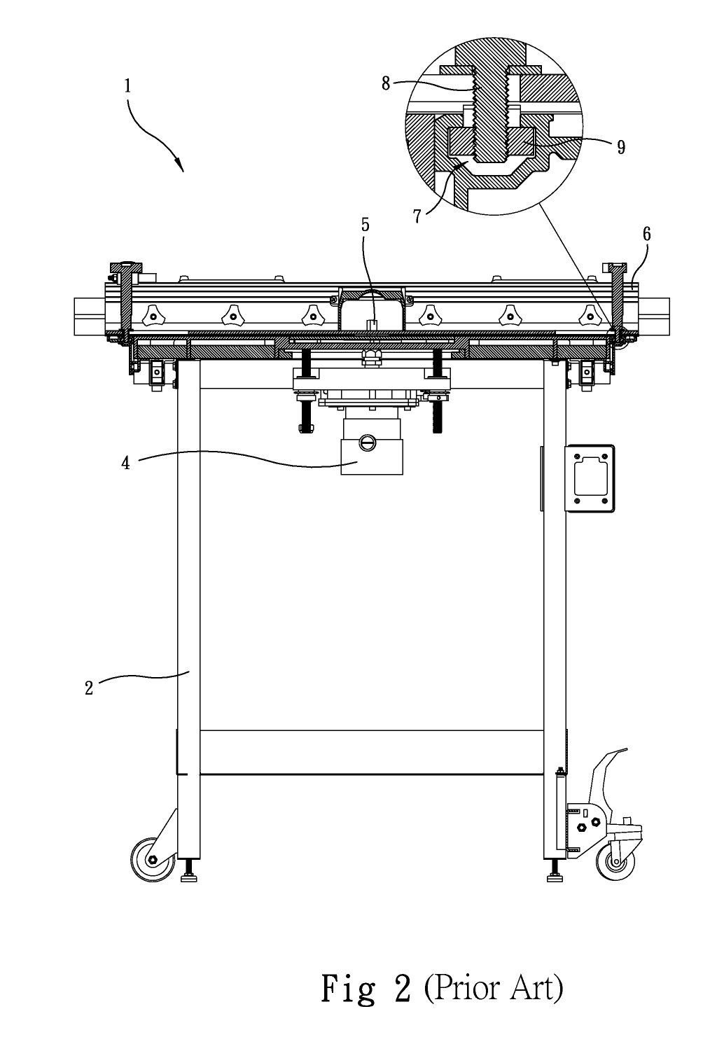

FIG. 3 is a perspective view of a woodworking machine according to a preferred embodiment of the present invention.

FIG. 4 is a side view of a woodworking machine according to the above preferred embodiment of the present invention.

FIG. 5 is an exploded perspective view of a woodworking machine according to the above preferred embodiment of the present invention.

FIG. 6 is a schematic diagram of a woodworking machine according to the above preferred embodiment of the present invention.

FIG. 7 is a sectional side view of a woodworking machine according to the above preferred embodiment of the present invention, illustrating that the woodworking machine is sectioned along plane 7-7 in FIG. 3.

FIG. 8 is another schematic diagram of a woodworking machine according to the above preferred embodiment of the present invention, illustrating the movement of the woodworking machine shown in FIG. 3.

FIG. 9 is a sectional side view of a woodworking machine according to the above preferred embodiment of the present invention, illustrating that the woodworking machine is sectioned along plane 9-9 in FIG. 3.

FIG. 10 is another schematic diagram of a woodworking machine according to the above preferred embodiment of the present invention.

### DETAILED DESCRIPTION OF THE PREFERRED EMBODIMENT

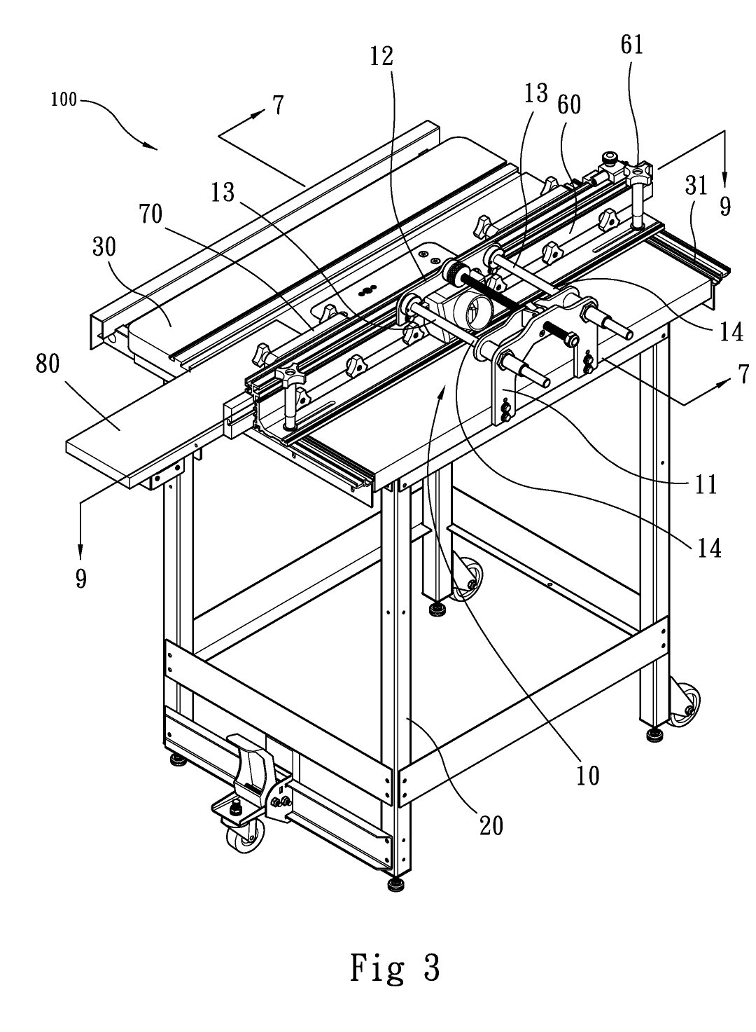

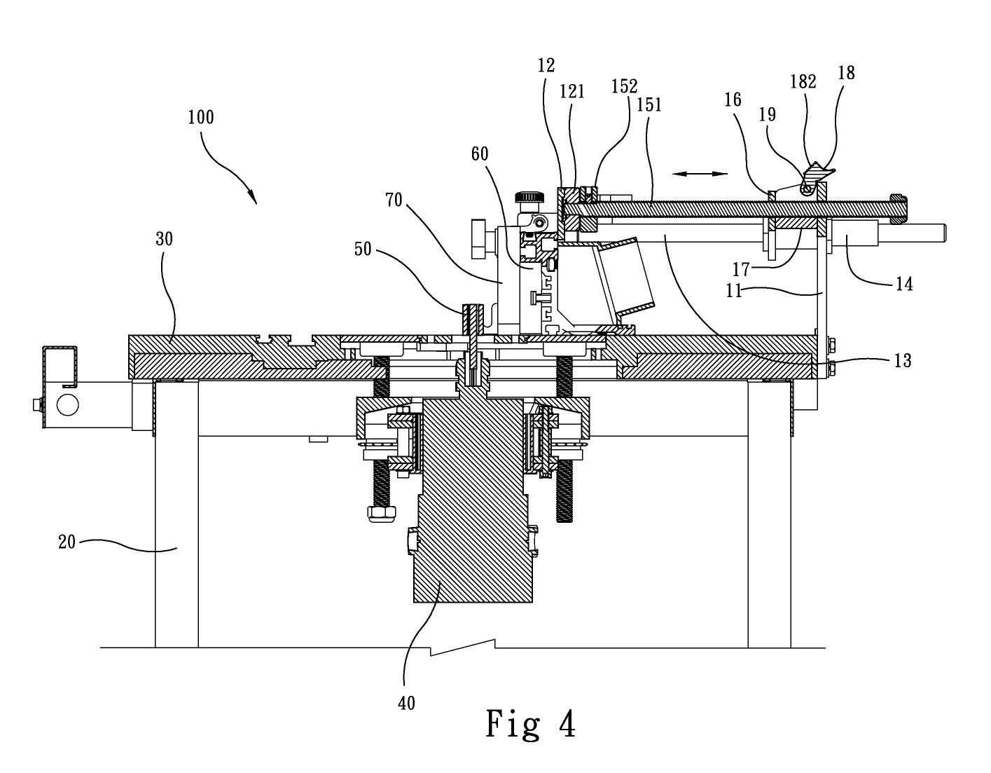

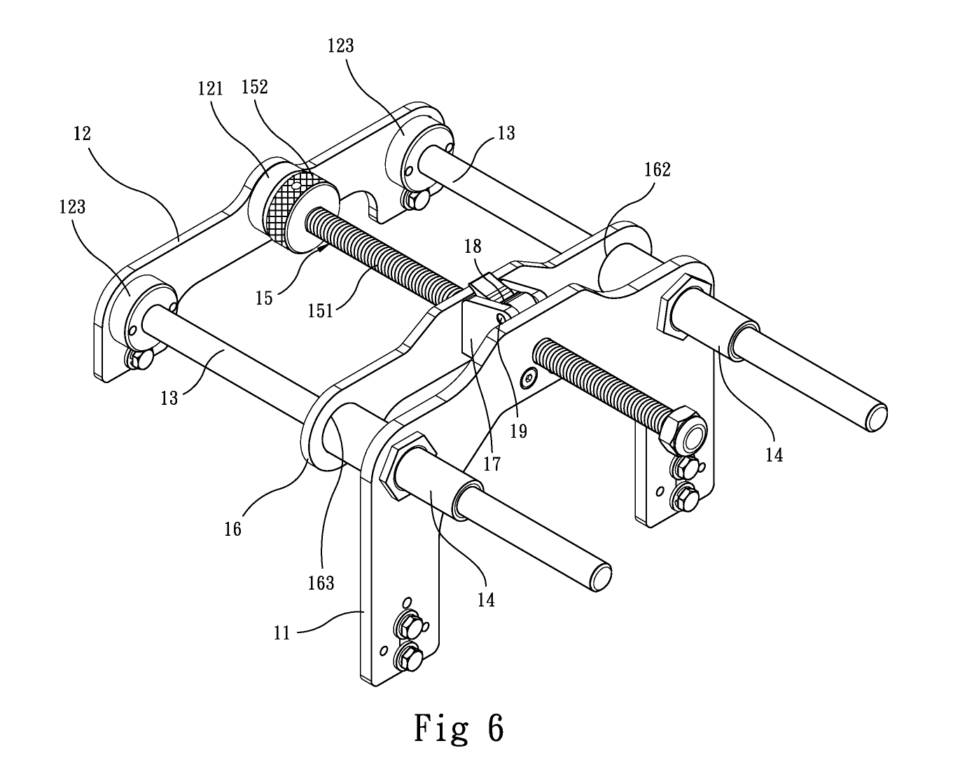

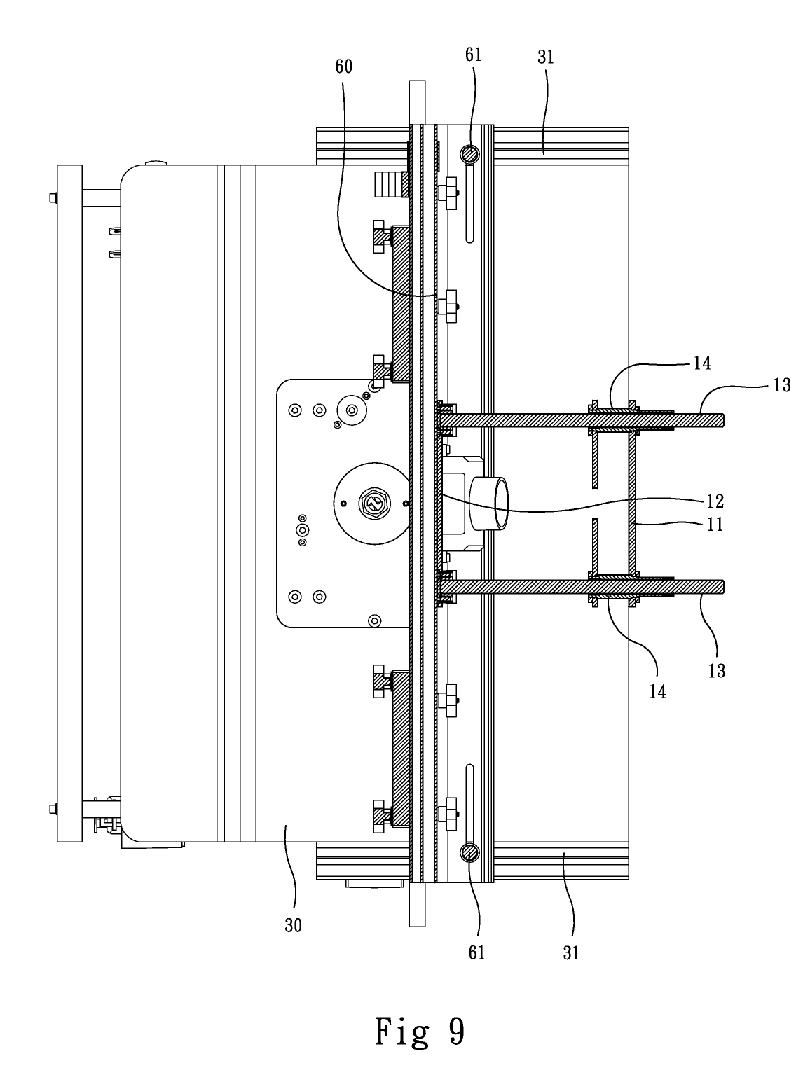

Referring to FIG. 3 to FIG. 10 of the drawings, a woodworking machine, such as a router 100 for a work piece according to a preferred embodiment of the present invention is illustrated, in which the woodworking machine comprises a base frame 20, a work platform 30 supported on the base frame 20, a driving unit 40 also supported by the base frame 20, a rotary cutter unit 50, a supporting panel 60, and a rapid positioning apparatus 10.

The rotary cutter unit 50 is supported on the work platform 30 and is mechanically connected to the driving unit 40 so that the driving unit 40 is arranged to drive the rotary cutter 50 unit to perform a predetermined cutting procedure on the work piece.

The supporting panel 60 is movably provided on the work platform 30 for biasing against the work piece when the cutting procedure is performed on the work piece.

The rapid positioning apparatus 10 comprises a first guiding member 13 and a second guiding member 130 spacedly extended from the supporting panel 60, wherein the first guiding member 13 and the second guiding member 130 are arranged to restrict a movement of the supporting panel 60 on the work platform 30 at a transverse direction of the first guiding member 13 and the second guiding member 130 such that the supporting panel 60 is only capable of moving on the work platform 30 along a predetermined direction which is substantially parallel to the first guiding member 13 and the second guiding member 130. Each of the first guiding member 13 and the second guiding member 130 is a circular rod having a smooth surface.

According to the preferred embodiment of the present invention, the work platform 30 further has a plurality of sliding slots 31 spacedly and parallelly formed thereon, wherein the supporting panel 60 is slidably mounted on the sliding slots 31 so that it is capable of sliding on the work platform 30 along the sliding slots 31. More specifically, in order to slidably connect the supporting panel 60 onto the work platform 30, the supporting panel 60 further has a plurality of locking members 61 provided thereon and are arranged to selectively engage with the sliding slots 31. In other words, the locking members 61 are capable of selectively engaging with the sliding slots 31 so as to prevent sliding of the supporting panel 60 on the work platform 30. When the locking members 61 are selectively disengaged from the sliding slots 31, the supporting panel 60 is capable of sliding on the work platform 30 along the sliding slots 31.

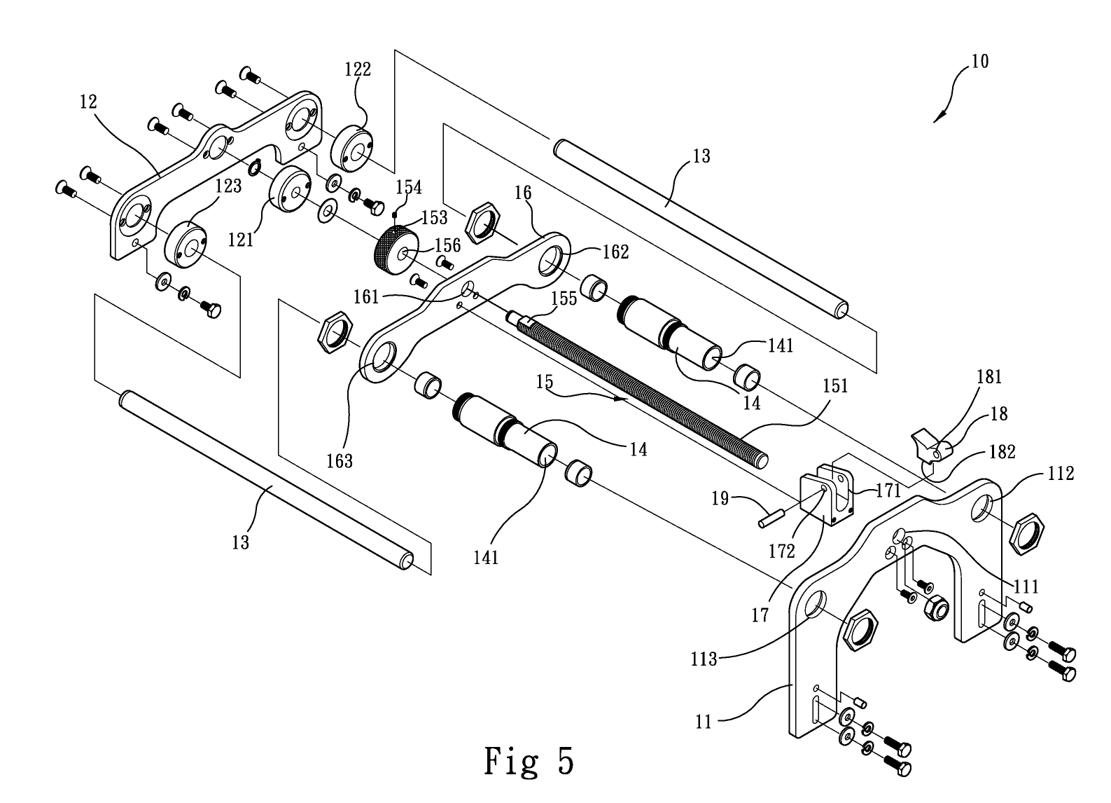

Referring to FIG. 5 of the drawings, the rapid positioning apparatus 10 of the woodworking machine of the present invention is provided on the work platform 30 and is arranged to stabilize and retain the position of the supporting panel 60 when it is sliding along the sliding slots 31 so as to ensure that the supporting panel 60 is capable of smoothly sliding along the work platform 30 (i.e. the sliding slots 31) for effectively performing a desirable woodworking procedure.

The rapid positioning apparatus 10 comprises the first guiding member 13, the second guiding member 130, a first supporting member 11, a second supporting member 12, a plurality of tubular sleeves 14 provided on said first guiding member 13 and the second guiding member 130 respectively, a threaded rod 15, an adjustment member 16, an adjustment base 17, a locking switch 18, and a pivot 19.

Referring to FIG. 3 to FIG. 6 of the drawings, the first supporting member 11 is connected to a side edge portion of the work platform 30 and is upwardly extended therefrom, wherein the first supporting member 11 has a main through slot 111 formed thereon, and a plurality of guiding holes 112, 113 also formed on the first supporting member 11 at positions which are spacedly apart from two sides of the main through slot 111 respectively at a predetermined distance.

As shown in FIG. 3 to FIG. 6 of the drawings, the second supporting member 12 is provided on a side edge portion of the supporting panel 60 and is upwardly extended from the work platform 30, wherein the second supporting member 12 further has a main support bearing 121 and a plurality of auxiliary bearings 122, 123 also provided on the second supporting member 12 at a position which are spacedly apart from two sides of the supporting bearing 121 at the predetermined distance.

Each of the first guiding member 13 and the second guiding member 130 has a smooth exterior surface, and has one end movably connected to the corresponding guiding hole 112 (113) of the first supporting member 11, and has another end connected to the corresponding auxiliary bearing 122 (123) of the second supporting member 12. In other words, the first guiding member 13 and the second guiding member 130 are connected to the auxiliary bearing 122, 123 respectively, and are extended between the first supporting member 11 and the second supporting member 12 in a substantially parallel manner.

Each of the tubular sleeves 14 has a through sliding slot 141 formed thereon, wherein the first guiding member 13 and the second guiding member 130 are arranged to slidably penetrate the sliding slot 141 so as to slidably connect to the tubular sleeves 14 respectively.

The threaded rod 15, as its name implies, has a threaded portion 151 and a tuning portion 152, wherein the threaded portion 151 is extended between the first supporting member 11 and the second supporting member 12, and has one end arranged to penetrate the main through slot 111 of the first supporting member 11, and another end arranged to be supported by the main support bearing 121, wherein the tuning portion 152 is connected to threaded portion 151 at the second supporting member 12. In other words, the second main support bearing 121 is arranged to rotatably support the threaded portion 151 of the threaded rod 15.

The tuning portion 152 of the threaded rod 15 further has a through hole 156, wherein the threaded portion 151 is arranged to pass through the through hole 156 of the tuning portion 152 so that the threaded portion 151 is extended from the tuning portion 152. Moreover, the tuning portion 152 further has a fastening hole 153 radially formed thereon to communicate with the through hole 156, wherein the tuning portion 152 is fastened to the threaded portion 151 through a connecting screw 154 screwing through the fastening hole 153. Accordingly, the treaded portion 151 of the threaded rod 15 further has a fastening portion 155 aligned with the connecting screw 154, wherein the connecting screw 154 is arranged to screw along the fastening hole 153 and bias against the fastening portion 155 in such a manner that when the tuning portion 152 is rotated, the traded portion 151 is also driven to rotate by the connecting screw 154. In other words, the threaded rod 15 can be driven to rotate by rotating the tuning portion 152.

Referring to FIG. 3 to FIG. 6 of the drawings, the adjustment member 16 has a through bored hole 161, and a plurality of securing holes 162, 163 spacedly formed at two sides of the through hole 161 respectively, wherein each of the securing holes 162, to 163 are spaced apart from the through bored hole 161 at a predetermined distance. The threaded portion 151 of the threaded rod 15 is arranged to pass through the through bored hole 161, while the corresponding tubular sleeves 14 are arranged to be mounted at the securing holes 162 (163) respectively so as to allow the adjustment member 16 to be mounted at a position between the first supporting member 11 and the second supporting member 12. At the same time, the adjustment member 16 is also operatively mounted at a positioned between the first supporting member 11 and the second supporting member 12.

Furthermore, the adjustment base 17 is operatively provided between the adjustment member 16 and the first supporting member 11, and has an indention slot 171 defining two sidewalls thereof, wherein each of the two sidewalls has a pivot slot 172 formed thereon.

As shown in FIG. 3 to FIG. 7 of the drawings, the locking switch 18 has a plurality of connecting holes 181 alignedly formed on two sides thereof, wherein one of the side surfaces of the locking switch 18 is suitably threaded to form a threaded surface 182. The locking switch 18 is pivotally mounted in the indention slot 171 of the adjustment base 17, wherein the pivot 19 is arranged to penetrate the pivot slots 172 of the adjustment base 17 and the connecting holes 181 of the locking switch 18 so as to pivotally connect the locking switch 18 to the indention slot 171 of the adjustment base 17 for allowing the locking switch 18 to pivotally move between an adjustment position and a releasing position.

The operation of the woodworking machine of the present invention is described as follows: when a user wishes to adjust a position of the supporting panel 60, he or she may loosen the locking switch 18 and slide the supporting panel 60 on the work platform 30 to a desirable position. The first guiding member 13 and the second guiding member 130 of the rapid positioning apparatus 10 are arranged to parallelly and spacedly extend between the guiding holes 112, 113 and the second supporting member 12 respectively. Moreover, the first supporting member 11 and the second supporting member 12 are connected to the work platform 30 and the supporting panel 60 respectively so that when the supporting panel 60 is slid by the user of the present invention, the movement of the supporting panel 60 is substantially restrained by the first guiding member 13 and the second guiding member 130 so that the supporting panel 60 can only slide in a direction which is substantially perpendicular to the first guiding member 13 and the second guiding member 130 and is substantially parallel to the sliding slot 31 of the work platform (because the first guiding member 13 and the second guiding member 130 can only slide along the sliding slots 141 respectively so that the sliding movement of the first guiding member 13 and the second guiding member 130 are substantially restrained by the sliding slots 141). Since the supporting panel 60 can only slide on the work platform 30 along a direction which is substantially parallel to the sliding slot 31, the supporting panel 60 is prevented from accidentally diverting from its desirable sliding path. As a result, the supporting panel 60 can slide on the work platform 30 in a very smooth and accurate manner so as to enhance the work performance of the woodworking machine of the present invention.

Furthermore, when the user wishes to finely adjust the position of the supporting panel 60, he or she can switch the locking switch 18 to the adjustment position. When the locking switch 18 is at the adjustment position, the locking switch 18 is pivotally moved to engage the threaded surface 182 with the threaded portion 151 of the threaded rod 15.

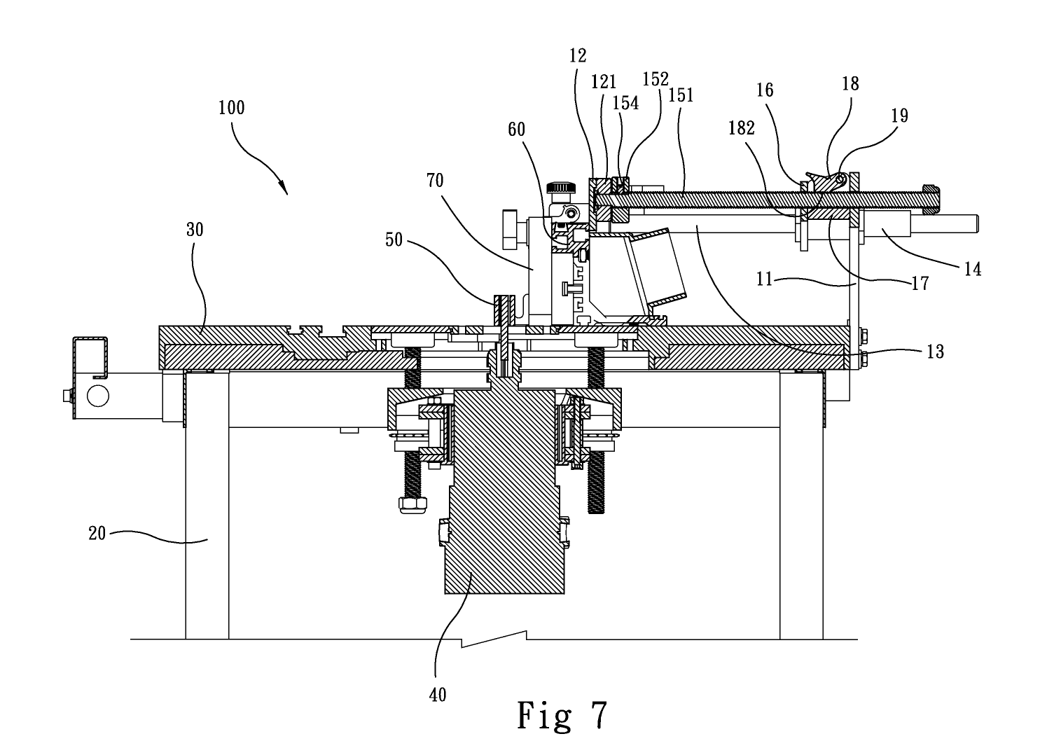

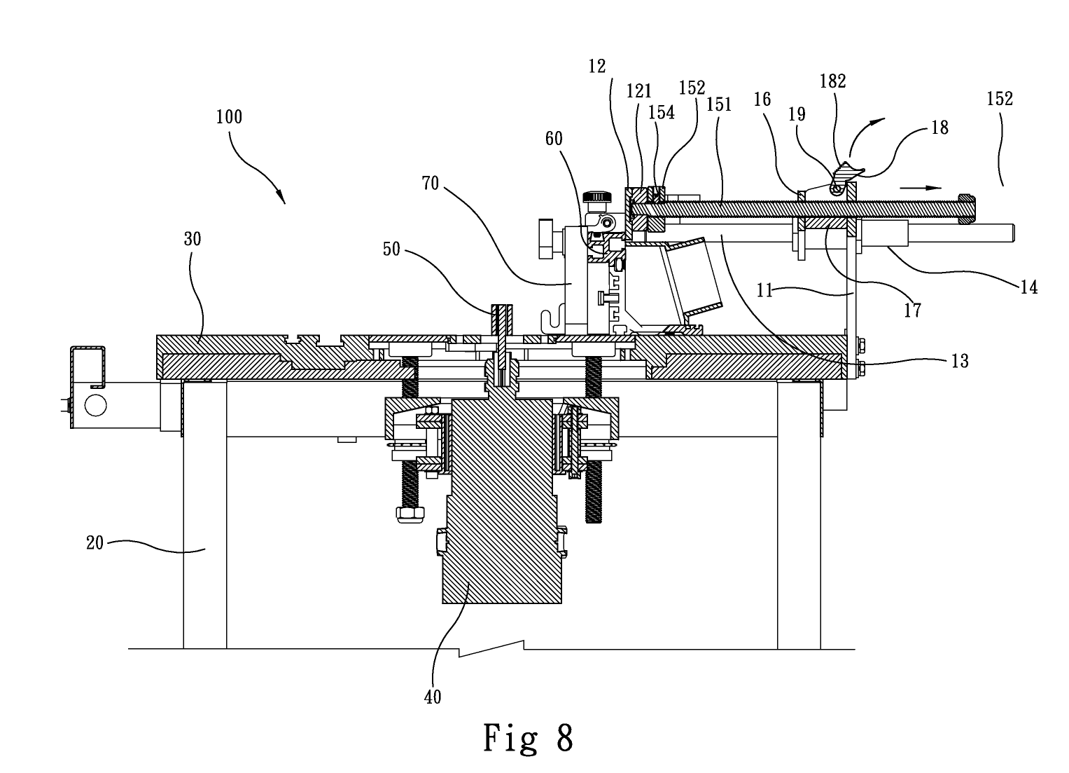

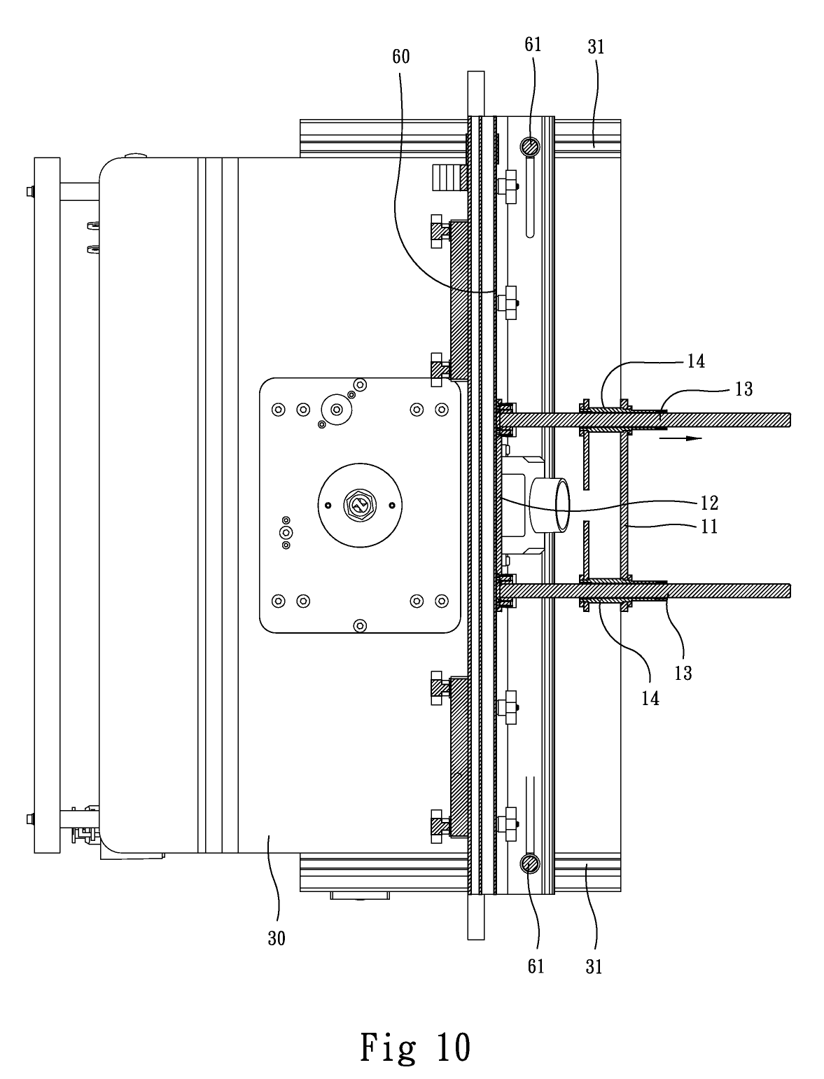

Referring to FIG. 7 to FIG. 9 of the drawings, by rotating the tuning portion 152 of the threaded rod 15, the threaded portion 151 and the threaded surface 182 of the locking switch 18 is engaged to drive the threaded rod 15 to move longitudinally (as shown in FIG. 8 and FIG. 10 of the drawings) in a finely controlled manner so as to finely adjust the position of the supporting panel 60. When the supporting panel 60 is finely moved to a desirable position, the user may pivotally switch the locking switch 18 back to the releasing position. After that, the user may lock up the position of the supporting panel 60 by operating on the locking members 61.

From the description above, one skilled in the art will appreciate that the rapid positioning apparatus 10 is capable of guiding the supporting panel 60 to move on the work platform 30 in a controlled manner without departing from its original sliding path. Moreover, the rapid positioning apparatus 10 also allows the supporting panel 60 to be finely slid on the work platform 30 so as to enhance an overall effectiveness and efficiency of the woodworking machine of the present invention.

Moreover, the woodworking machine of the present invention further comprises a biasing member 70 provided on the supporting panel 60 for biasing against the work piece 80 (as shown in FIG. 5) so as to prevent the work piece 80 from detaching from the supporting panel 60.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A woodworking machine for a work piece, comprising:
a base frame;
a work platform supported on said base frame;
a driving unit supported by said base frame;
a rotary cutter unit supported on said work platform and is mechanically connected to said driving unit so that said driving unit is arranged to drive said rotary cutter unit to perform a predetermined cutting procedure on said work piece;
a supporting panel movably provided on said work platform for biasing against said work piece when said cutting procedure is performed on said work piece; and
a rapid positioning apparatus, which comprises:
a first supporting member which is mounted on said work platform and has a plurality of guiding holes spacedly formed on said first supporting member;
a second supporting member mounted on said supporting panel,
a first guiding member; and
a second guiding member, wherein said first guiding member and said second guiding member are spacedly extended from said second supporting member to connect to said guiding holes of said first supporting member respectively, wherein said first guiding member and said second guiding member are arranged to restrict a movement of said supporting panel on said work platform at a transverse direction of said first guiding member and said second guiding member such that said supporting panel is only capable of moving on said work platform along a predetermined direction which is substantially parallel to said first guiding member and said second guiding member.

2. The woodworking machine, as recited in claim 1, wherein each of said first guiding member and said second guiding member is a circular rod having a smooth surface.

3. The woodworking machine, as recited in claim 1, wherein second supporting member has a plurality of auxiliary bearings provided thereon for supporting said first guiding member and said second guiding member respectively.

4. The woodworking machine, as recited in claim 1, wherein said first supporting member further has a main through slot formed between said guiding holes, wherein said rapid positioning apparatus further comprises a plurality of tubular sleeves provided on said first guiding member and said second guiding member respectively, a threaded rod, an adjustment member, an adjustment base, and a locking switch, wherein said first supporting member has a main through slot formed thereon, wherein each of said tubular sleeves has a through sliding slot formed thereon, wherein said first guiding member and said second guiding member are arranged to slidably penetrate said sliding slot so as to slidably connect to said tubular sleeves respectively, wherein said threaded rod has a threaded portion and a tuning portion, wherein said threaded portion is extended between said first supporting member at said main through slot and said second supporting member, wherein said tuning portion is connected to threaded portion at said second supporting member, wherein said adjustment member has a through bored hole, and a plurality of securing holes spacedly formed at two sides of said through hole respectively, wherein said threaded portion of said threaded rod is arranged to pass through said through bored hole, while said tubular sleeves is arranged to be mounted on said corresponding securing hole so as to allow said adjustment member to be mounted at a position between said first supporting member and said second supporting member, wherein said adjustment member is operatively connected to said tubular sleeves, wherein said locking switch has a threaded surface and is pivotally to said adjustment base in such a manner that said adjustment base is selectively and pivotally moved between an adjustment position and a releasing position, wherein in said adjustment position, said locking switch is pivotally moved to allow said threaded surface to engage with said threaded portion of said threaded rod, wherein in said releasing position, said locking switch is pivotally moved so that said threaded surface is disengaged from said threaded portion of said threaded rod.

5. The woodworking machine, as recited in claim 4, wherein said second supporting member further has a main support bearing for rotatably supporting said threaded portion of said threaded rod.

6. Said woodworking machine, as recited in claim 4, wherein said tuning portion of said threaded rod further has a through hole, wherein said threaded portion is arranged to pass through said through hole of said tuning portion so that said threaded portion is extended from said tuning portion, wherein said tuning portion further has a fastening hole radially formed thereon to communicate with said through hole, wherein said tuning portion is fastened to said threaded portion through a connecting screw screwing through said fastening hole.

7. The woodworking machine, as recited in claim 4, wherein said rapid positioning apparatus further comprises a pivot, wherein said adjustment base has an indention slot defining two sidewalls thereof, wherein each of said two sidewalls has a pivot slot formed thereon, wherein said locking switch has a plurality of connecting holes alignedly formed on two sides thereof, wherein the pivot is arranged to penetrate said pivot slots of the adjustment base and said connecting holes of said locking switch so as to pivotally connect said locking switch to said indention slot of said adjustment base for allowing said locking switch to pivotally move between said adjustment position and said releasing position.

8. The woodworking machine, as recited in claim 1, wherein said work platform further has a plurality of sliding slots spacedly and parallelly formed thereon, wherein said supporting panel is slidably mounted on said sliding slots so that said supporting panel is capable of sliding on said work platform along said sliding slots, wherein said supporting panel further has a plurality of locking members provided thereon and are arranged to selectively engage with said sliding slots, wherein said locking members are capable of selectively engaging with said sliding slots so as to prevent sliding of said supporting panel on said work platform, wherein said locking members are also selectively disengaged from said sliding slots so that said supporting panel is capable of sliding on said work platform along said sliding slots.

9. The woodworking machine, as recited in claim 1, further comprising a biasing member provided on said supporting panel for biasing against said work piece so as to prevent said work piece from detaching from said supporting panel.
